(19) United States
(12) Patent Application Publication
(10) Pub. No.: US 2017/0024702 A1
(43) Pub. Date: Jan. 26, 2017

(54) APPARATUS AND METHOD FOR MANAGING CALENDAR EVENTS RELATED TO LOCATION IN A SHARED CALENDAR SYSTEM

(71) Applicant: Motorola Mobility LLC, Chicago, IL (US)

(72) Inventor: Amit Kumar Agrawal, Bangalore (IN)

(21) Appl. No.: 14/803,721

(22) Filed: Jul. 20, 2015

(51) Int. Cl. G06Q 10/10; G06F 3/0484; G06F 3/0481

(52) U.S. Cl. CPC G06Q 10/1093; G06F 3/0481; G06F 3/0484

(57) ABSTRACT

A method of operation of an electronic shared calendar system includes determining that a device has changed location from a first location to a second location by accessing location information from location hardware of the device. The calendar entries of the electronic shared calendar implemented by the device are checked to determine calendar entries that are related to activities at the first location. Calendar entries of the electronic shared calendar related to activities at the first location are hidden so that they are not visible when the electronic shared calendar is displayed on a display of the device or by other parties viewing the shared calendar on other devices.

### FIELD OF THE DISCLOSURE

The present disclosure relates to computerized calendar system.

### BACKGROUND

Computerized or “electronic” calendar systems are very useful tools and these tools are more prominently useful in the business world. As business tools, calendars are often shared and indicate user availability for the purpose of setting up meetings accordingly with different users. Many business calendar users create recurring events on their calendar such as, for example, “Commute back/forth to Work”, “Lunch”, “Organizing”, “sending monthly/weekly report”, “birthday reminders”, etc. These calendar entries relate to personal events and activities that are specific to the user. Such calendar entries are usually created so that the user can be promptly reminded of such events, but also to serve as an indication to other users that they should not schedule any other activities such as meetings during such personally allocated timeslots.

In calendar systems where the user's calendar entries are visible to other users, the user may add notification language to inform the user about the timeslot such as “Lunch—Please do not schedule”. However, the various commercially available calendar systems each provide different configuration options. For example, in some systems, if calendar entries are designated as private or personal, other users will see these calendar entries as unavailable but will not see the details of the entry. This may be accomplished by greying-out the calendar entries or using some other “busy” indication for the entries that prevent other persons from scheduling activities during such timeslots designated as busy.

A difficulty occurs however when such personal time is related to a specific location such as where the user lives or their primary work location. For example, personal calendar entries such as, “Commute back/forth to Work”, “Lunch”, etc. may not be applicable if the user travels to another location, especially if the location is in a different time zone. For coworkers, these calendar entries can result in confusion and inconvenience because these timeslots may be shown as unavailable when in fact, the user would be available in the different location. These personal calendar entries therefore lose their usefulness in a travel situation. Although some existing calendar systems automatically adjust the time zone for the calendar, they do not have the capability of addressing the user's personally designated timeslots that would no longer be applicable in a new time zone or in a different location that may be within the same time zone for which the calendar entries were intended.

### BRIEF DESCRIPTION OF THE DRAWINGS

FIG. 1 is a diagram of an example daily view of one day in a computerized calendar system showing various user entries.

FIG. 2 is a diagram of the example daily view of one day as in FIG. 1 where private or personal settings prevent others viewing the calendar from seeing details of the various user entries.

FIG. 3 is a flow chart showing a process in accordance with various embodiments.

FIG. 4 is a block diagram of an example device that implements a computerized calendar system in accordance with one embodiment.

FIG. 5 is a diagram of an example computerized calendar system in accordance with an embodiment.

### DETAILED DESCRIPTION

Briefly, the present disclosure provides a calendar system that can adjust calendar entries based on context. One disclosed method of operation of an electronic shared calendar system includes determining that a device has changed location from a first location to a second location by accessing location information from location hardware of the device. The calendar entries of the electronic shared calendar implemented by the device are checked to determine calendar entries that are related to activities at the first location. Calendar entries of the electronic shared calendar related to activities at the first location are hidden so that they are not visible when the electronic shared calendar is displayed on a display of the device or by other parties viewing the shared calendar on other devices.

One aspect of the present disclosure is a method that includes determining, by a processor, that a device has changed location from a first location to a second location by accessing location information from location hardware of the device; checking, by the processor, calendar entries of an electronic shared calendar accessed by the device, to determine calendar entries that are related to activities at the first location; and hiding, by the processor, calendar entries of the electronic shared calendar, such that the calendar entries related to the first location are not visible when the electronic shared calendar is displayed on a display of the device.

In some embodiments, determining, by the processor, calendar entries that are related to activities at the first location may be accomplished by identifying, by the processor, calendar entries that involve only the device's owner and that are recurring calendar entries. In some embodiments, the method may include sending, by the processor, an update to a server, such that calendar entries of the electronic shared calendar are not visible when the electronic shared calendar is displayed on a display of other devices of parties sharing the electronic shared calendar. The method may also include determining, by the processor, that the second location is in a different time zone than the first location; and adjusting, by the processor, calendar entries that are not related to the first location to times appropriate for the time zone of the second location.

The method may also include determining, by the processor, that the device has changed location from the second location back to the first location; and restoring, by the processor, the hidden calendar entries of the electronic shared calendar, such that calendar entries related to the first location are visible when the electronic shared calendar is displayed on a display of the device.

Another aspect of the present disclosure is a device that includes a display; a user interface; location hardware; and a processor, operatively coupled to the user interface, the display and the location hardware. The processor is operative to provide display data for calendar entries of an electronic shared calendar to the display such that the calendar entries are displayed on the display; determine that the device has changed location from a first location to a second location by accessing location information from the location hardware; check calendar entries of the electronic shared calendar, to determine calendar entries that are related to activities at the first location; and modify entries of the electronic shared calendar to hide calendar entries of the electronic shared calendar, such that calendar entries related to the first location are not visible when the electronic shared calendar is displayed on the display.

The processor may determine calendar entries that are related to activities at the first location by identifying calendar entries that involve only the device's owner and that are recurring calendar entries. The processor may also send an update to a server, such that calendar entries of the electronic shared calendar are not visible when the electronic shared calendar is displayed on a display of other devices of parties sharing the electronic shared calendar. The processor may determine that the second location is in a different time zone than the first location; and may adjust calendar entries that are not related to the first location to times appropriate for the time zone of the second location. The processor may be further operative to determine that the device has changed location from the second location back to the first location; and restore the hidden calendar entries of the electronic shared calendar, such that calendar entries related to the first location are visible when the electronic shared calendar is displayed on the display.

Another aspect of the present disclosure is a system that includes the device described above, and a server, operatively coupled to the device, where the server provides the electronic shared calendar.

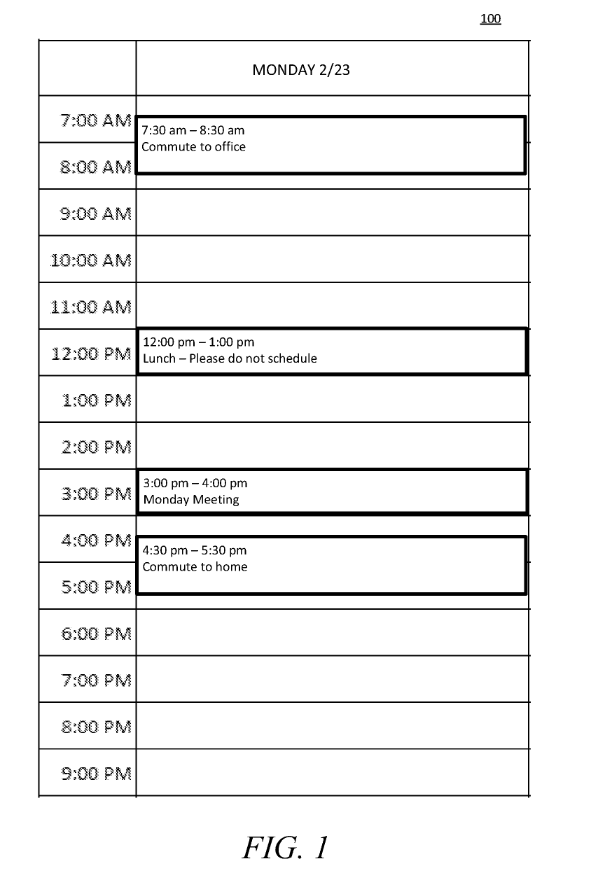

Turning now to the drawings wherein like numerals represent like components, FIG. 1 is a diagram of an example daily calendar view 100 of a computerized calendar system. The calendar view 100 shows timeslots for day and shows various calendar entries input by the calendar owner that correspond to the particular day shown. The calendar view 100 illustrated in FIG. 1 is a calendar view that may be displayed on a display of a computing device such as, but not limited to, a laptop computer, a smartphone or some other electronic device that provides a calendar access capability.

The terms “computerized” and “electronic” are used interchangeably herein as modifiers to the term “calendar system” which when used herein as “computerized calendar system” or “electronic calendar system” refer interchangeably to a calendar system that may be implemented as executable instructions (also referred to herein as “instructions”, “executable code”, “code”, “software” or “firmware” with or without modifiers) executing on one or more processors, or as a calendar system implemented independently as hardwired circuitry or logic, or as a combination of hardwired circuitry or logic, or other components, and executable instructions executing on one or more processors. Such executable instructions are stored in non-volatile, non-transitory memory that may be an independent component, an integrated component that is integrated with the one or more processors, or some distributed combination of independent and integrated memory operatively coupled together to the one or more processors or to other components. Such a “computerized calendar system” or “electronic calendar system” may also be implemented using any independent component or combination of components such as, but not limited to, ASICs (application-specific-integrated-circuits), DSPs (digital signal processors), hardwired circuitry (logic circuitry), state machines, FPGAs (field programmable gate arrays), CPUs executing software or firmware, or combinations thereof without limitation. Further, the term “calendar system” or “calendar” as used herein without the modifiers “computerized” or “electronic” are to be understood as still referring to such a “computerized calendar system” or “electronic calendar system.”

The example calendar view 100 shows a specific day, Monday, February 23, however the calendar view could be adjusted to show a weekly view, a monthly view, a bi-weekly view, etc. In the example calendar view 100 is also related to a shared calendar in that other users may obtain a view of the calendar owner's schedule. Thus for example, other users may see that the calendar owner commutes to the office between 7:30 AM and 8:30 AM and then commutes back home between 4:30 PM and 5:30 PM. The other users may also see that the calendar owner schedules lunch between 12 PM and 1 PM and has posted a note asking that the other users not schedule any meetings during the calendar owner's designated lunchtime. The calendar owner also has a calendar entry for the timeslot of 3 PM to 4 PM which is designated for a Monday meeting. The timeslots designated for commuting to the office, commuting back home, and for lunch may be considered as “user only” entries in that they are reminders of the calendar owner's for the owner's benefit, and also to prevent other users who share the calendar from scheduling meetings or other activities during those predetermined timeslots.

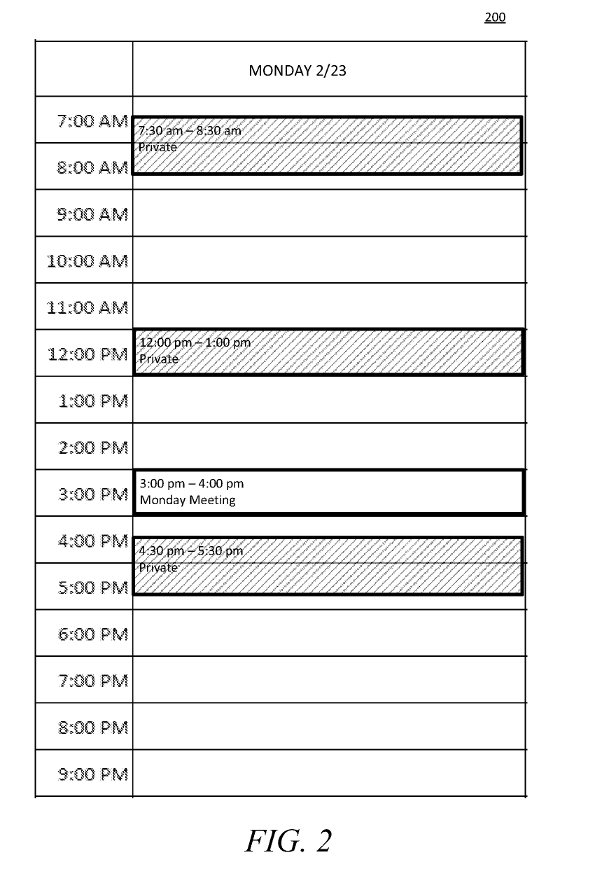

FIG. 2 provides another calendar view 200 which may correspond to the same calendar entries shown in FIG. 1. More particularly, FIG. 2 is a diagram of the example daily view of the one day (Monday, February 23) shown in FIG. 1, where private or personal settings prevent others who share and view the calendar from seeing details of the various user entries of the calendar owner. To achieve this in the calendar view 200, the calendar owner has set an option to designate certain timeslots as “private” or “personal” time. Therefore when other users who share the calendar view the calendar view 200, they will see those private times designated and displayed as grayed out or otherwise not available for scheduling meetings or other activities.

As can be seen in the calendar view 200, the calendar owner has designated private time between 7:30 AM and 8:30 AM, between 12 PM and 1 PM, and again between 4:30 PM and 5:30 PM. Those timeslots are designated as private and are shown as grayed out areas in the calendar view 200. However the timeslot between 3 PM and 4 PM for the “Monday meeting” is not grayed out it is not designated as private or personal. This is an indication that the Monday meeting may have other participants in addition to the calendar owner/user. Any of the other timeslots that are available, in other words timeslots that have not been designated as private, or that have not been otherwise scheduled by the calendar owner, are available timeslots that other users who share the calendar and who can view the calendar view 200, may use accordingly to schedule meetings or other activities with the calendar owner.

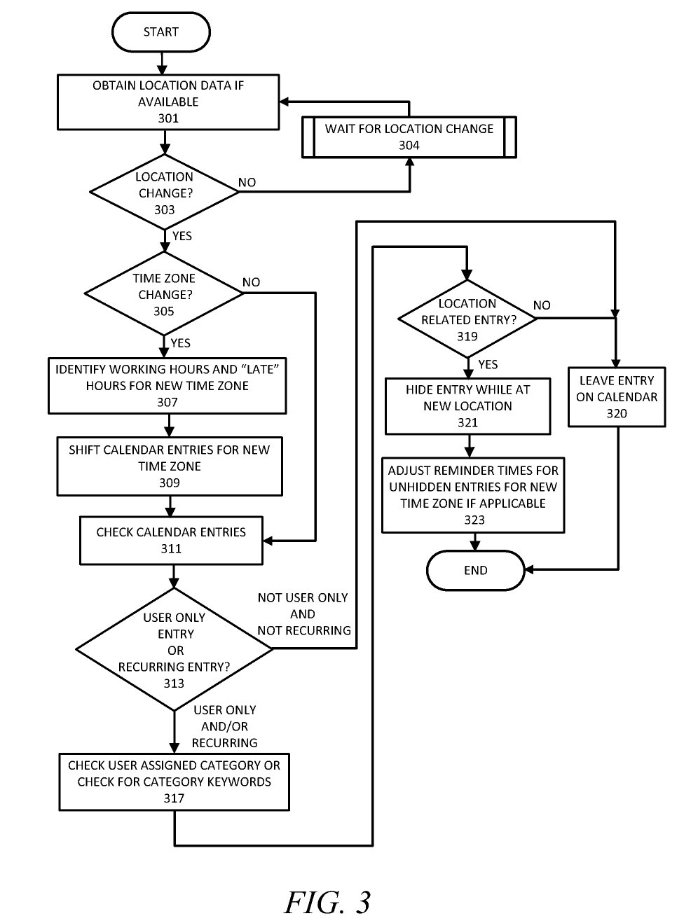

FIG. 3 is a flow chart showing a process in accordance with various embodiments and will now be described in conjunction with the calendar view 100 and calendar view 200. The method of operation begins and in operation block 301, a processor attempts to obtain location data for the calendar owner if available. The location data is specific to the calendar owner's electronic device (i.e. laptop, smarthphone, etc.) and may be obtained from GPS hardware, or from a network connection, etc. If the processor determines that no location change has occurred in decision block 303, then the processor will wait for a location change as shown in operation block 304 and will obtain location data if available in operation block 301 upon the occurrence of a location change.

If a location change occurs in decision block 303, the processor will determine if a time zone change has occurred in decision block 305. If a time zone change has not occurred decision block 303, then the processor will proceed to operation block 311 and will begin to check calendar entries. However if a time zone change has occurred in decision block 305, then the processor will proceed to operation block 307. In operation block 307, the processor will identify “working” hours and “late” hours for the new time zone. In operation block 309, the processor will shift calendar entries for the new time zone accordingly. In some embodiments, a query may be displayed asking the user to confirm that the calendar entries should be shifted for the new time zone. In such embodiments, the processor will shift the calendar entries for the new time zone in response to user input confirming the this change should be made. After making these adjustments for the time zone change, the processor will proceed to operation block 311 and check calendar entries. For embodiments in which user confirmation is required at operation block 309, the processor will skip to operation block 311 if a user confirmation is not received.

In decision block 313, the processor will determine if a calendar entry is a “user only” entry or is a recurring entry. A calendar entry may be one or both of a user only entry and a recurring entry, or it may be neither. For example, in the calendar view 200, the timeslots scheduled from 7:30 AM to 8:30 AM, and from 4:30 PM to 5:30 PM, which are designated as private, are “user only” entries because they are related to the user commuting to the office and commuting home respectively. The time designated from 12 PM to 1 PM which is also designated as private, is also a user only entry because it is related to the user's lunchtime. In addition to these entries being user only entries, the user may have entered these events as recurring entries because, in this example, the user will need to commute to work and back home again Monday through Friday during a normal work week. Therefore in addition to these times being “user only” entries, they may also be recurring entries. However, a user only entry need not be a recurring entry. For example, a doctor's appointment may be a user only entry, but need not be, and most likely would not be, a recurring entry.

The calendar owner/user's scheduled Monday meeting between 3 PM and 4 PM is not a user only entry because it may include other participants, and may or may not be a recurring entry. For example it may be recurring, if the user has schedule the meeting for every Monday of every week for the current year or the current month. In that case the processor may consider the Monday meeting entry to be a recurring entry.

In decision block 313, if the calendar entry is determined to be not a user only entry and not a recurring entry, then the processor will proceed to operation block 320 and will leave the calendar entry on the calendar. The method of operation will then terminate as shown, or will proceed to evaluate the next calendar entry.

In decision block 313, if the processor determines that a calendar entry is a user only entry or is a recurring entry, then the processor will proceed to operation block 317 and will check if any user assigned category has been designated and will check for category keywords within the activity description shown in the calendar entry. The processor will be able to do that notwithstanding any settings the user has made. For example if the user has set a “private” or “personal” option that prevents shared calendar users from seeing details of the calendar entry as shown in the calendar view 200, the processor will still be able to access the details to evaluate the calendar entry.

Thus for example, if the processor determines that the timeslots between 7:30 AM and 8:30 AM and between 4:30 PM and 5:30 PM contain the keyword “commute”, then the processor may be determine this calendar entry as being a location related entry. This is done specifically in decision block 319. In decision block 319, the processor determines if any of the calendar entries are location related entries. If the calendar entry is determined not to be a location related entry in decision block 319, then the processor proceeds to operation block 320 and leaves the entry on the calendar. Sometimes a recurring entry detected in decision block 313 may be determined to be location independent at decision block 319. For example, a recurring meeting that takes place during working hours at one location, may be attended remotely by participants in different locations and different time zones by using teleconferencing capabilities. In such cases, the processor may detect the teleconference details at decision block 319 and therefore determine that the recurring meeting is not location dependent. In that case, the meeting will be left on the calendar as shown in operation block 320. In another example, a non-recurring, single time meeting may be location dependent. For example, a local pub crawl would require the user to be present at the location of the pubs. In that case, the processor may detect a meeting point at the old location at decision block 319 and therefore determine that the meeting is location dependent. In that case, the related calendar entry will be hidden in operation block 321 while the user is at the new location, and reminder times will be adjusted in operation block 323 accordingly.

It is to be understood, that the procedure of the flowchart illustrated in FIG. 3 is gone through for each calendar entry of the calendar. Therefore for clarity, although various looping operations have not been indicated on the flowchart, it is to be understood that these looping operations are present such that the processor will loop through all of the calendar entries until each one of the calendar entries is checked in accordance with the procedures indicated by the various decision blocks and operation blocks shown in the flowchart of FIG. 3.

Returning to decision block 319, if the calendar entry is determined to be a location related entry, then in operation block 321 the processor will proceed to hide the calendar entry while the user is located at the new location. The processor will determine if the user is at the new location by checking the location data as shown in operation block 301, decision block 303, and operation block 304 as was discussed above. In operation block 323, the processor will also adjust any reminder times such as when e-mail reminders are sent or pop up reminders, and will adjust those times for non-hidden entries for the new time zone (in cases where the user has moved to a new time zone as was determined in decision block 305 as discussed above). The processor will temporarily deactivate any reminders for location based calendar entries that were hidden, as long as the user remains at the new location. In some embodiments, a query may be displayed asking the user to confirm that the calendar entries should be hidden in operation block 321 for the new location. In such embodiments, the processor will perform the operations of operation block 321 and operation block 323 in response to user input confirming that these changes should be made. If a user confirmation is not received at operation block 321 in such embodiments, the method of operation will terminate and no changes to the calendar based on location will be made.

In some embodiments, the calendar system provides the calendar owner/user an option to manually enter in categories for time entries so that these calendar entries can be automatically hidden when the user changes locations. Examples of such categories may include, but are not limited to, “commuting,” “lunch/meal times,” “personal reports preparation,” whether the calendar entry is a “user event” or a “shared event” or user defined categories. Therefore, in operation block 317, the processor may check for such user assigned categories. Otherwise, the processor looks for keywords in the calendar entries and categorizes the calendar entries automatically during the process of FIG. 3, or at the time a calendar entry is created by the user.

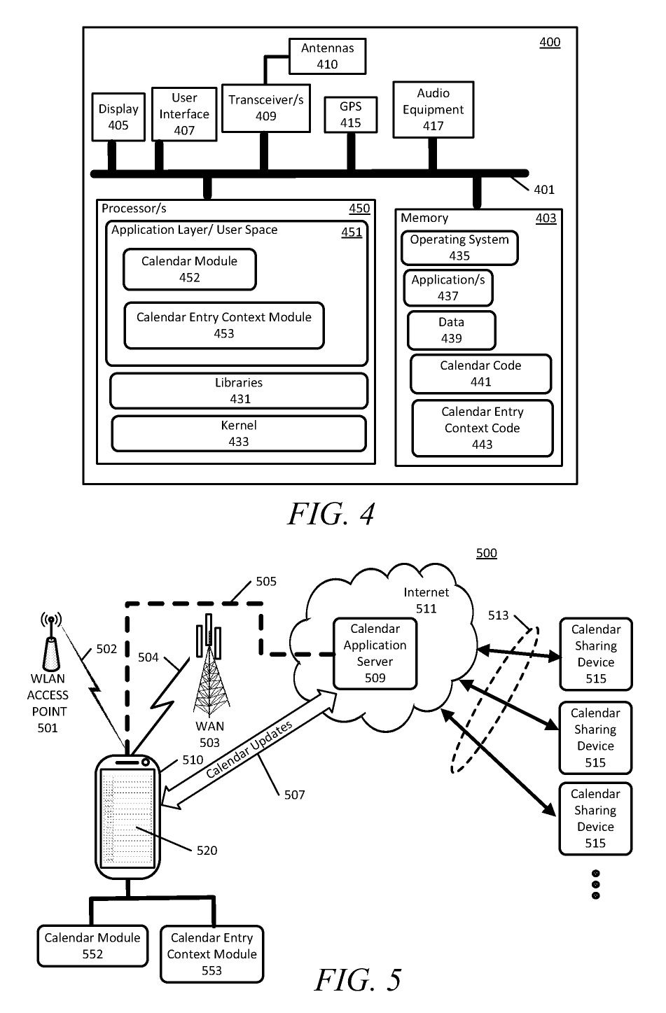

It is to be understood that the operations of the flowchart of FIG. 3 may involve interaction with a server, such as a cloud server or an enterprise server, etc., where a primary calendar application is implemented on the server. For example, the processor of the device may send updates to the server related to which calendar entries of the calendar owner/user should be hidden based on the location change. More specifically, the location change from a first location to a second location is determined by a computing device processor that accesses location information from either internal hardware or by way of a network connection. The server hosting the primary calendar application then displays the shared calendar with the appropriate calendar entries hidden or appropriately grayed out, based on updates received from the processor of the calendar owner/user's computing device. One such example of a computing device is shown in FIG. 4.

FIG. 4 is a block diagram of a device 400 that is a computing device or mobile device such as, but not limited to, a smartphone, that implements a computerized calendar system in accordance with one embodiment. The device 400 includes one or more processors 450, memory 403, a display 405, user interface 407, one or more radio transceivers 409 (such as, but not limited to CDMA, UMTS, GSM, etc. and/or WLAN transceivers capable of implementing IEEE 802.11x radio interfaces or equivalent, and/or baseband hardware for a “tethering” radio protocol such as, but not limited to, Bluetooth® or Bluetooth® Low Energy, etc.), one or more antennas 410 operatively coupled to the one or more radio transceivers 409, GPS hardware 415, and audio equipment 417. All of the components shown are operatively coupled to the one or more processors 450 by one or more internal communication buses 401. Audio equipment 417 includes speakers, microphones and audio processing. The audio equipment 417 may include, among other things, at least two microphones or a microphone array, at least one speaker, signal amplification, analog-to-digital conversion/digital audio sampling, echo cancellation, etc., which may be applied to one or more microphones and/or one or more speakers.

The memory 403 is non-volatile and non-transitory and stores executable code for an operating system 435 that, when executed by the one or more processors 450, provides an application layer (or user space) 451, libraries 431 (also referred to herein as “application programming interfaces” or “APIs”) and a kernel 433. The memory 403 also stores executable code for various applications 437, data 439, calendar code 441, and calendar entry context code 443 for checking and updating calendar entries as described with respect to the flowchart of FIG. 3. The memory 403 may be operatively coupled to the one or more processors 450 via the internal communications buses 401 as shown, may be integrated with the one or more processors 450, or may be some combination of operatively coupled memory and integrated memory.

In addition to applications 437, the one or more processors 450 are operative to launch and execute the calendar code 441 and the calendar entry context code 443 to implement a computerized calendar in accordance with an embodiment. The one or more processors 450 are operative to launch and execute the calendar code 441 and the calendar entry context code 443 to implement the calendar module 452 and the calendar entry context module 453, respectively. However it is to be understood that the various “modules” described herein can be implemented in other ways that are contemplated by the present disclosure and that the example shown in FIG. 4 is only one possible implementation.

For example, the calendar module 452 and calendar entry context module 453 may be implemented in a client-server or thin client manner in which a primary calendar application resides on a server that is accessed by the one or more processors 450 using an Internet Protocol (IP) connection, and the calendar module 452 formed wirelessly using the one or more transceivers 409. In that case, the calendar module 452 may be implemented as a thin client or may communicate with primary calendar application using a client-server hierarchy, etc. Put another way, in the example of FIG. 2, the “modules” are shown implemented as executable instructions executed by the one or more processors 450 that configure the one or more processors 450 to perform the methods of operation according to the embodiments. However, it is to be understood that the modules (also referred to herein as “components”) may be implemented as distributed systems, or may be components of a distributed system having a server, such as an enterprise server, running a primary calendar application where the calendar entry context module 453 resides on the device 400 and is operative to update the view of the user's calendar accordingly by communicating with the enterprise server, etc. In embodiments that include executable instructions such executable instructions or “code” may be stored in the operatively coupled, non-volatile, non-transitory memory 403 that may be accessed by the one or more processors 450 as needed.

Therefore, it is to be understood that any of the above described example modules or components in the example device 400 may be implemented as software (i.e. executable instructions or executable code) that may operate independently from a server or that may operate in conjunction with a primary application provided by a server, such as an enterprise server executing additional code on one or more processors, etc. Therefore the device 400 illustrated in FIG. 4 and described herein provides just one example embodiment and is not to be construed as a limitation on the various other possible implementations that may be used in accordance with the various embodiments.

FIG. 5 is a diagram of an example electronic shared calendar system 500 in accordance with an embodiment. A device 510, which is a smartphone in this example, includes internal components similar to those of the device 400 illustrated in FIG. 4. For example, the device 510 includes a calendar module 552 and a calendar entry context module 553. The device 510 is operative to display a calendar view 520 on a display.

The device 510 is operative to access either or both of a wide area network (WAN 503) using a WAN radio interface 504, and a wireless local area network access point 501 using a WLAN radio interface 502. Using these radio networks, the device 510 is operative to establish an Internet Protocol (IP) connection 505 with the Internet 511 and with a calendar application server 509. The calendar module 552 is operative to send and receive calendar updates 507 to and from the calendar application server 509, respectively.

Various other users may share the device 510 calendar view 520 using an appropriate calendar sharing device 515 which may also connect to the Internet 511 and send and receive calendar updates 513 to and from calendar application server 509, respectively. As the device 510 is moved, along with the calendar owner/user of the device 510, the calendar entry context module 553 performs the method of operation illustrated in FIG. 3, and sends resulting calendar updates 507 to the calendar application server 509 which hosts the shared calendar. Accordingly, the calendar sharing devices 515 are able to access and display the calendar view 520 in order to schedule meetings or other events with the device 510 user.

An electronic shared calendar system has thus been disclosed and described that provides, among other advantages, advanced management of recurring calendar events which involves only the calendar owner/user based on context such as location based, single user entries, and categories of activities related to specific locations. Among further advantages, the disclosed system provides a shared calendar system in which managing calendar events and scheduling meeting is improved in convenience because the calendar system correctly indicates user availability to other users who share calendar views, when the calendar owner/user is traveling or at different locations than their primary work location.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A method comprising:
determining, by a processor, that a device has changed location from a first location to a second location by accessing location information from location hardware of the device;
checking, by the processor, calendar entries of an electronic shared calendar accessed by the device, to determine calendar entries that are related to activities at the first location; and
hiding, by the processor, calendar entries of the electronic shared calendar, such that the calendar entries related to the first location are not visible when the electronic shared calendar is displayed on a display of the device.

2. The method of claim 1, wherein determining, by the processor, calendar entries that are related to activities at the first location comprises:
identifying, by the processor, calendar entries that involve only the device's owner and that are recurring calendar entries.

3. The method of claim 1, further comprising:
sending, by the processor, an update to a server, such that calendar entries of the electronic shared calendar are not visible when the electronic shared calendar is displayed on a display of other devices of parties sharing the electronic shared calendar.

4. The method of claim 1, further comprising:
determining, by the processor, that the second location is in a different time zone than the first location; and
adjusting, by the processor, calendar entries that are not related to the first location to times appropriate for the time zone of the second location.

5. The method of claim 1, further comprising.
determining, by the processor, that the device has changed location from the second location back to the first location; and
restoring, by the processor, the hidden calendar entries of the electronic shared calendar, such that calendar entries related to the first location are visible when the electronic shared calendar is displayed on a display of the device.

6. A device comprising:
a display;
a user interface;
location hardware; and
a processor, operatively coupled to the user interface, the display and the location hardware and operative to:
provide display data for calendar entries of an electronic shared calendar to the display such that the calendar entries are displayed on the display;
determine that the device has changed location from a first location to a second location by accessing location information from the location hardware;
check calendar entries of the electronic shared calendar, to determine calendar entries that are related to activities at the first location; and
modify entries of the electronic shared calendar to hide calendar entries of the electronic shared calendar, such that calendar entries related to the first location are not visible when the electronic shared calendar is displayed on the display.

7. The device of claim 6, wherein the processor is operative to determine calendar entries that are related to activities at the first location by:
identifying calendar entries that involve only the device's owner and that are recurring calendar entries.

8. The device of claim 6, wherein the processor is further operative to:
send an update to a server, such that calendar entries of the electronic shared calendar are not visible when the electronic shared calendar is displayed on a display of other devices of parties sharing the electronic shared calendar.

9. The device of claim 6, wherein the processor is further operative to:
determine that the second location is in a different time zone than the first location; and
adjust calendar entries that are not related to the first location to times appropriate for the time zone of the second location.

10. The device of claim 6, wherein the processor is further operative to
determine that the device has changed location from the second location back to the first location; and
restore the hidden calendar entries of the electronic shared calendar, such that calendar entries related to the first location are visible when the electronic shared calendar is displayed on the display.

11. A system comprising;
the device of claim 1; and
a server, operatively coupled to the device, the server providing the electronic shared calendar.
